(19) United States
(12) Patent Application Publication
(10) Pub. No.: US 2020/0230811 A1
(43) Pub. Date: Jul. 23, 2020

(54) ACTUATOR

(71) Applicant: Massachusetts Institute of Technology, Cambridge, MA (US)

(72) Inventors: Sangbae Kim, Brookline, MA (US); Benjamin Katz, Somerville, MA (US)

(73) Assignee: Massachusetts Institute of Technology, Cambridge, MA (US)

(21) Appl. No.: 16/410,887

(22) Filed: May 13, 2019

Related U.S. Application Data
(60) Provisional application No. 62/818,481, filed on Mar. 14, 2019.
(60) Provisional application No. 62/795,546, filed on Jan. 22, 2019.

(51) Int. Cl. B25J 9/12; B25J 9/10

(52) U.S. Cl. CPC B25J 9/126; F16H 1/28; B25J 9/104; B25J 9/102

(57) ABSTRACT

Actuators with one or more gears disposed at least partially within a central bore passing axially through a stator and/or a rotor of an actuator are described.

### CROSS-REFERENCE TO RELATED APPLICATIONS

This application claims the benefit under 35 U.S.C. § 119(e) of U.S. provisional application Ser. No. 62/795,546, filed Jan. 22, 2019, and of U.S. provisional application Ser. No. 62/818,481, filed Mar. 14, 2019, the disclosures of each of which are incorporated by reference in their entirety.

### FIELD

Disclosed embodiments are related to actuators.

### BACKGROUND

Actuators are used to generate motion upon receiving a control signal. Examples of types of actuators include electric motors, hydraulic cylinders, solenoids, piezoelectric materials, thermal bimorphs, and shape memory-alloys, to name a few. Actuators are often evaluated on a number of performance metrics, including, for example, output force, output torque, output speed, force density, torque density, and/or output efficiency to name a few. However, certain aspects of an actuator can limit its usefulness. For example, an actuator that is large and heavy may be precluded from use in applications where an actuator that is more compact and lightweight is desired.

### SUMMARY

In one embodiment, an actuator includes a stator and a rotor that is rotatable relative to the stator. The rotor is coaxial with the stator, and one or more gears are disposed at least partially within a central bore passing axially through the stator and/or the rotor. The one or more gears are also operatively coupled to the rotor.

In another embodiment, a method of operating an actuator includes: driving one or more gears with a rotor of the actuator, where the one or more gears are at least partially disposed within a central bore passing axially through the rotor and/or a stator of the actuator.

In yet another embodiment, a robotic limb includes a first robotic limb segment; a second robotic limb segment; a first joint operatively coupled to a proximal portion of the first robotic limb segment; and a second joint operatively coupled to a distal portion of the first robotic limb segment and a proximal portion of the second robotic limb segment. A first actuator is configured to rotate the first joint about a first axis. A second actuator is operatively coupled to the first actuator and configured to rotate the first joint about a second axis. A third actuator is configured to rotate the second joint about a third axis. One or more selected from the group of the first actuator, the second actuator, and the third actuator are a compact actuator that includes a rotor that is rotatable relative to the stator. The rotor is coaxial with the stator, and the compact actuator includes one or more gears disposed at least partially within a central bore passing axially through the stator and/or the rotor. The one or more gears are operatively coupled to the rotor.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1A is a front view of one embodiment of an actuator;

FIG. 1B is a side view of the actuator shown in FIG. 1A;

FIG. 1C is a back view of the actuator shown in FIG. 1A;

FIG. 2 is an exploded view of one embodiment of an actuator;

FIG. 3A is a front view of one embodiment of an actuator;

FIG. 3B is a cross sectional side view of the actuator shown in FIG. 3A;

FIG. 4A is a side view of one embodiment of an actuator;

FIG. 4B is a cross sectional front view of the actuator shown in FIG. 4A;

FIG. 5A is a perspective view of one embodiment of a robotic limb;

FIG. 5B is a front view of the robotic limb shown in FIG. 5A; and

FIG. 5C is a side view of the robotic limb shown in FIG. 5A.

### DETAILED DESCRIPTION

In view of the limitations of current actuators, such as their size and weight, the Inventors have recognized the benefits associated with providing light and/or compact actuators that are still capable of providing a desired output characteristic. Specifically, the Inventors have recognized the benefits associated with an actuator with one or more gears disposed at least partially within a central bore passing axially through the stator and/or the rotor of the actuator. In such an embodiment, an axial length of the one or more gears may overlap with an axial length of the rotor and/or the stator to reduce an overall axial length of the actuator. In such an embodiment, the rotor may be rotatable relative to the stator, and may also be coaxial with the stator. The one or more gears may also be operatively coupled to the rotor such that rotation of the rotor drives the one or more gears to output motion from an output of the actuator operatively coupled to the one or more gears.

The above embodiment of an actuator may minimize the axial length and correspondingly reduce the weight of an actuator. In some embodiments, this may be due to the same mechanical structure being used to support both the stator and the one or more gears. Additionally, such an arrangement may allow a large diameter stator and/or rotor as well as the one or more gears to be integrated into a relatively small volume. While offering these benefits, the disclosed actuators may also be designed for low cost, low weight, low volume, high torque density, low transmission ratio, backdrivability, high bandwidth force control through proprioception (i.e., without a dedicated sensor), tolerance to external impact, and/or any other appropriate design consideration.

In the embodiments described herein, it should be understood that any appropriate actuator output may be used. For instance, the output may be a shaft, a plate, studs, bolts or any other appropriate output that is operatively coupled to the one or more gears and that is capable of transmitting a desired force, torque, and/or displacement output by the one or more gears due to rotation of an associated rotor as the disclosure is not limited to any particular type of output.

The Inventors have also appreciated numerous advantages associated with a robotic limb that comprises one or more actuators as disclosed herein to control the motion of one or more joints disposed between two or more adjacent robotic limb segments. Using such actuators in a robotic limb may enable robots that are lighter and less expensive. Such a robotic limb may also be more modular which may make it easier to repair and/or modify. Due to these considerations, such a robot may enable rapid experimentation of dynamic behaviors in hardware, as opposed to simulations of such behaviors in software, as well as reducing the cost and complexity of robotic systems including these robotic limbs.

As noted above, in one embodiment, an actuator may include one or more gears disposed at least partially within a central bore passing axially through a stator and/or rotor of the actuator. Depending on the particular construction, the one or more gears may either be entirely, or partially, disposed in a central bore that overlaps with an axial length of the stator and/or rotor. For example, a percentage of an axial length of the one or more gears disposed within the central bore of a rotor and/or stator of an actuator may be equal to or greater than 5%, 10%, 20%, 30%, 40%, 50%, or any other appropriate percentage. Correspondingly, the axial length of the more gears disposed in the central bore may be less than or equal to 100%, 90%, 80%, 70%, 60%, and/or any other appropriate percentage. Combinations of the foregoing are contemplated, including, an axial length of the one or more gears disposed in the central bore of a rotor and/or stator being between 5% and 100%, 50% and 100%, and/or any other appropriate combination. In either case, by partially, or completely, disposing the one or more gears within the central bore of the stator and/or rotor, the axial length of the actuator, and correspondingly the weight, of the actuator may be reduced.

In some embodiments, the rotor and the stator may at least partially, and in some embodiments, entirely overlap along their length. For example, an axial length of the stator and/or the rotor may overlap by an amount that may be equal to or greater than 5%, 10%, 20%, 30%, 40%, 50%, and/or any other appropriate percentage of a length of the stator and/or rotor. Correspondingly, an axial length of the stator and/or the rotor may overlap an amount that is less than or equal to 100%, 90%, 80%, 70%, 60%, and/or any other appropriate percentage of a length of the stator and/or rotor. Combinations of the above noted ranges are contemplated, including an overlap of the stator and rotor that is between or equal to 5% and 100% of a length of the stator and/or rotor though other combinations and ranges are also contemplated as the disclosure is not so limited. For the sake of clarity, the embodiments described herein are primarily directed to actuators in which the stator is disposed at least partially within the rotor. However, embodiments in which the rotor is disposed at least partially within the stator are also contemplated as the disclosure is not so limited.

It should be understood that the embodiments disclosed herein may be constructed using any appropriate set of gears to provide a desired gearing ratio and/or other output characteristic. For example, in one embodiment, the one or more gears may comprise a planetary gear system including a sun gear located at a center of the gear system which may serve as an input to the gear system that is operatively coupled to a rotor of an actuator. As the sun gear spins due to rotation of the associated rotor, it may rotate a set of planet gears that are mounted on a movable carrier called the planet carrier. The planet gears engage with an outer gear called a ring gear, which is coaxial with the sun gear and which may not rotate in some embodiments. An output of the planetary gear system may be coupled to the planet carrier which may function as an output from the overall actuator in some embodiments. However, while a planetary gear system is used in much of the discussion of this disclosure, it should be understood that the inclusion of other types of gears with the disclosed actuators are also contemplated. For example, the one or more gears may also include a harmonic drive system, a spur gear system, a cycloidal gear system, and/or any other appropriate system of gears, as the disclosure is not limited in this regard.

It should be understood that depending on the desired operational characteristics, an actuator may be constructed such that the one or more gears produce any desired gear ratio. For example, in one embodiment, the gear ratio of the one or more gears may be between or equal to 1:1 and 20:1, 3:1 and 15:1, or 6:1 and 10:1. However, embodiments in which a gear ratio provided by the one or more gears of an actuator have a gear ratio that is less than or greater than those noted above are also contemplated as the disclosure is not limited in this fashion.

As used herein, the gear ratio may generally refer to the ratio between the rotation rate of a last gear and the rotation rate of a first gear in a system of gears. For example, if the last gear rotates at a rate that is twice as fast as the rate at which the first gear rotates, that system of gears has a gear ratio of 2:1.

In some embodiments, an actuator may be backdrivable. For example, an actuator may be backdrivable when the one or more gears, and the associated rotor, may be driven in response to an external force being applied to the gears. In one such instance, an output may apply a force or torque to the one or more gears so that the one or more gears rotate in a direction of the applied force or torque. Depending on the particular embodiment, this may either occur when the actuator is otherwise stationary and/or during active driving of the actuator. Design considerations that may be balanced with one another to permit an actuator to be back driven may include balancing an overall gear ratio and friction within the actuator. For instance, larger amounts of friction and larger gear ratios may reduce the ability to back drive an actuator.

It should be noted that the actuator described herein may be implemented in any number of applications. For example, in some embodiments, an actuator may be used as part of a robotic system, such as a quadruped robot or a lower-body biped. However, in other embodiments, an actuator may be used as part of a car, a fan, a vacuum cleaner, an elevator, a food processor, and/or any number of other applications as the disclosure is not limited to the particular application in which the disclosed actuators are used.

In one embodiment, one or more of the actuators described herein may be used in the construction of a robotic limb. For example, the one or more actuators may drive the motion of one or more joints of the robotic limb about one or more axes of motion. In one such embodiment, the robotic limb may include at least a first robotic limb segment and a second robotic limb segment. The robotic limb may include a first joint that is operatively coupled to a proximal portion of the first robotic limb segment and a second joint that is operatively coupled to a distal portion of the first robotic limb segment and a proximal portion of the second robotic limb segment. However, it should be noted that a robotic limb may include any number of joints and/or limb segments as the disclosure is not limited in this fashion. In some embodiments, the above noted robotic limb may include a first actuator configured to rotate the first joint about a first axis, a second actuator operatively coupled to the first actuator and configured to rotate the first joint about a second axis, and a third actuator configured to rotate the second joint about a third axis.

Depending on the particular embodiment, the above noted actuators may be located directly at the individual joints and/or they may be removed from the joints with the outputs of the one or more actuators coupled to the joints through appropriate couplings including, but not limited to, belts, chains, linkages, and/or any other appropriate transmission system. Further, while a particular number of actuators, joints, and limb segments are noted above, any appropriate number and/or arrangement of these components, as well as any appropriate number and/or arrangement of rotational axes of the joints, are contemplated as the disclosure is not limited in this fashion. In some embodiments, at least one, and in some embodiments all, of the one or more actuators in the robotic limb may be a compact actuator as described herein.

However, robustness to impacts is another design criteria which may be considered for actuators used in legged robots. For example, contacts with the world at non-zero velocity are inevitable, even if the robot's control strategies work hard to avoid them. Further, any uncertainty in the terrain, any error in robot state estimation, and any disturbance can cause impacts with significant velocity. Therefore, in some embodiments, a robotic limb may be designed to mitigate the effects of impact on the actuators of the robotic limb. It should be understood that there are many ways in which the robotic limb may be designed for mitigating impacts. For example, one or more compliances may be introduced into a robotic limb including a series elastic actuator located in line with the one or more actuators. Alternatively, a compliance may be introduced into the robotic limb through a compliant end effector and/or foot located on a distal end of the robotic limb. Of course, the robotic limb may also be designed to mitigate impacts in other ways as the disclosure is not so limited.

As used herein, a stator may refer to a stationary portion of an actuator and a rotor may refer to one or more components of the actuator that rotate relative to the stator. In some embodiments, the rotor may also be coaxial with the stator. Depending on the particular embodiment, the stator may feature one or more poles corresponding to electrical windings disposed around a circumference of the stator, and the rotor may feature one or magnets disposed around a circumference of the rotor. When an electric current is supplied to the one or more poles, an electromotive force is produced according to the principle of electromagnetic induction. This magnetic field interacts with the one or more magnets of the rotor. If the one or more poles of the stator and the one or more magnets of the rotor are appropriately arranged, the rotor will rotate about its longitudinal axis relative to the stator in response to the magnetic field acting on the one or more magnets. Of course, different arrangements of the poles and/or the magnets with respect to the stator and/or the rotor are contemplated, as the disclosure is not limited in this fashion. For example, in some embodiments, the stator may include the one or more magnets, and the rotor may include the one or more poles.

Turning now to the figures, specific non-limiting embodiments are described in further detail. It should be understood that the various systems, components, features, and methods described relative to these embodiments may be used either individually and/or in any desired combination as the disclosure is not limited to only the specific embodiments described herein.

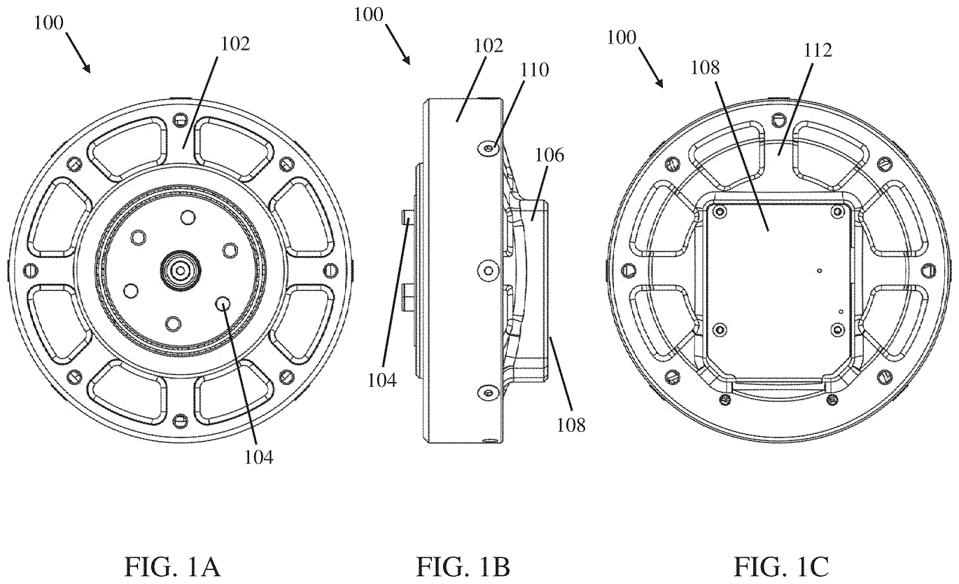

FIGS. 1A-1C depict various views of an actuator 100. From the front view, the exterior of the actuator includes a first housing portion 102 and one or more output studs 104. The first housing portion is connected to a second housing portion 112 by one or more fasteners 110 to form an overall housing within which the other components of the actuator may be disposed and/or otherwise integrated with. Although the fasteners are depicted as machine bolts in the drawings, it should be understood that any appropriate manner of joining the front and second housing portions may be used. For example, the front and second housing portions may be joined by an adhesive, brazing, mechanical interference, mechanical interlocking features, a weld, and/or any other appropriate form of connection. The second housing portion of the actuator also includes a control housing 106 which may either be coupled to, or integrally formed with, either the front or second housing portion. The actuator may also include a control housing lid 108 that is either permanently, or selectively, attached to the control housing using any of the above noted connection types.

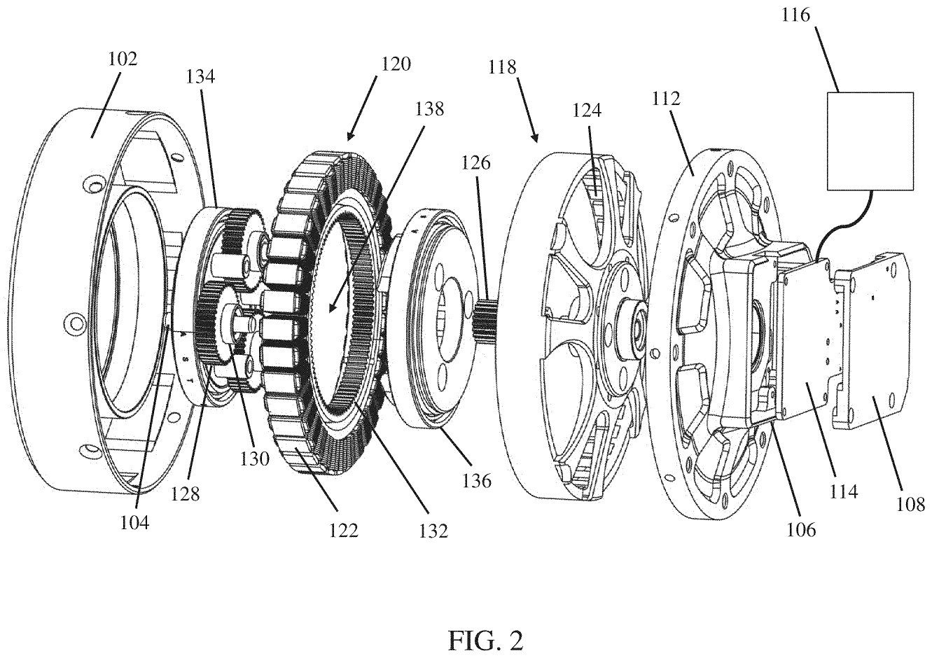

FIG. 2 depicts an exploded view of an actuator. Similar to the above, the actuator includes first and second housing portions 102 and 112 as well as a control housing 106 and control housing lid 108. The actuator may also include a power source 116 that is configured to provide power to a controller 114 of the actuator disposed within the control housing.

The actuator may include a rotor 118 and stator 120 disposed within an interior of the connected first and second portions of the housing 102 and 112. The controller 114 may be operatively coupled to the stator 120, which remains stationary relative to the first housing portion and the second housing portion. In the depicted embodiment, the stator includes one or more poles 122 which are powered and controlled by the associated controller. Specifically, when a current supplied by the controller passes through the one or more poles, an electromagnetic field is produced. The electromagnetic field interacts with one or magnets 124 that are disposed circumferentially around an axis of rotation of the rotor to cause the rotor to rotate about its longitudinal axis relative to the first housing portion, the second housing portion, and the stator.

In the depicted embodiment, the actuator includes one or more gears coupled to the rotor. Specifically, a sun gear 126 is operatively coupled to the rotor so that it rotates when the rotor rotates. The sun gear is operatively coupled to one or more planet gears 128 disposed around the sun gear. Each of the one or more planet gears is configured to rotate about one or more planet bearings 130, each of which is coaxial with its respective planet gear. The one or more planet gears are engaged with a stationary ring gear 132 that is disposed around the sun and planet gears so that the planet gears collectively rotate about the sun gear while remaining within the ring gear. The planet gears are coupled to, and disposed between, a planet carrier that is comprised of a front planet carrier 134 and a rear planet carrier 136. As the one or more planet gears rotate collectively about the sun gear, they cause the planet carrier to rotate, and thus cause the one or more output studs 104, which extend out from and are operatively coupled to the planet carrier, to rotate.

As described previously, when the components of FIG. 2 are assembled, the one or more gears of the planetary gear system, or other appropriate gear system may be disposed at least partially, and in some embodiments completely, within a central bore 138 of the stator 120 and/or rotor 118 of an actuator such that an axial length of the one or more gears overlap with an axial length of the rotor and/or stator. As shown in the figure, the central bore extends axially through the stator with an outer radial portion of the rotor surrounding the stator and the central bore. Thus, the central bore may be viewed as extending completely through the stator and partially through the rotor. However, embodiments in which the central bore extends completely through a rotor and partially through a stator, as well as embodiments in which the rotor is at least partially disposed within the stator, are also contemplated as the disclosure is not limited in this fashion. In either case, the one or more gears may extend in an axial direction such that at least a portion, and in some embodiments the entirety, of their axial length extends within a portion of the central bore that passes at least partially through the rotor and stator.

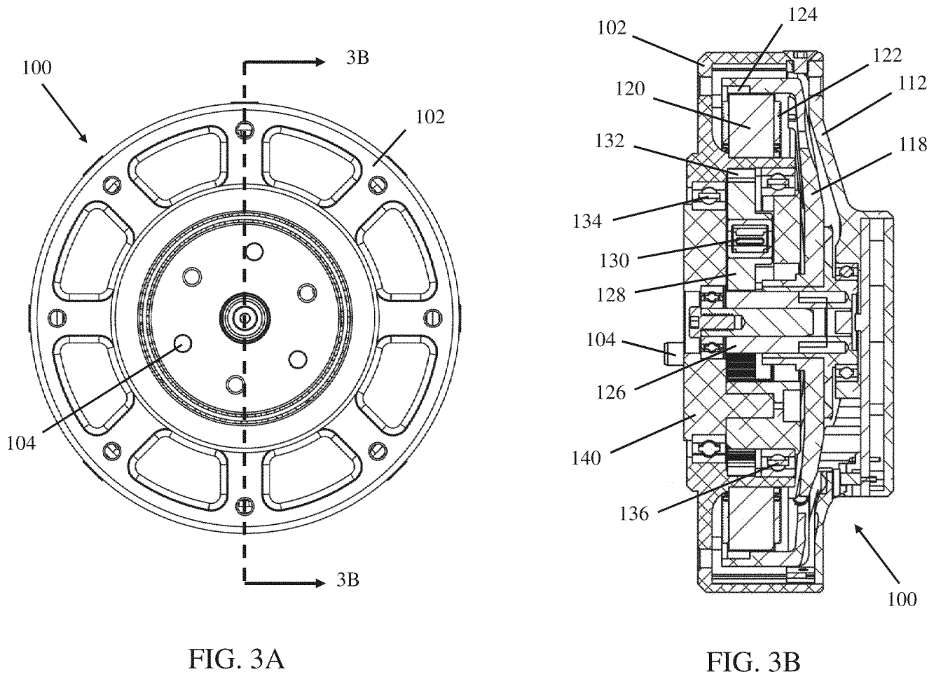

FIGS. 3A and 3B show a front view and corresponding cross sectional side view of one embodiment of an actuator 100. As above, the actuator comprises a first housing portion 102 connected to a second housing portion 112 to form a housing that the internal components of the actuator are disposed within. As illustrated in the drawings, the rotor 118 is disposed at least partially within the stator 120. However, as noted previously, in some embodiments, the stator may be disposed at least partially within the rotor. Further, as shown in the figures, the stator and the rotor may at least partially overlap along their axial lengths extending in a direction parallel to a rotational axis of the rotor. Further, in some embodiments, a majority of the axial lengths of the stator and the rotor may overlap.

FIG. 3B also illustrates the coupling between the sun gear 126 and the one or more planet gears 128. In the depicted embodiment, each of the one or more planet gears rotate about a planet bearing 130, and the teeth of the one or more planet gears are engaged with the corresponding teeth of a ring gear 132 disposed radially outwards from and surrounding the one or more planet gears and sun gear. The one or more planet gears are coupled to a planet carrier 140, which comprises a front planet carrier 134 and a rear planet carrier 136 that the planet gears are disposed between. Coupled to the planet carrier are one or more output studs 104, or other appropriate output from the actuator for providing a desired output motion, force, and/or torque. In some embodiments, a rotor of an actuator is operatively coupled to the sun gear, through an appropriate shaft, tube, pipe, cylinder, or other coupling capable of transmitting a rotational motion from the rotor to the sun gear or other appropriate portion of a gear system being used. In this particular embodiment, the sun gear is operatively engaged with the one or more planet gears. Again, the planet bearings are operatively coupled through one or more planet bearings to the planet carrier which is operatively coupled to the one or more output studs. Thus, rotating the rotor causes the one or more output studs, or other output structure, to rotate as well.

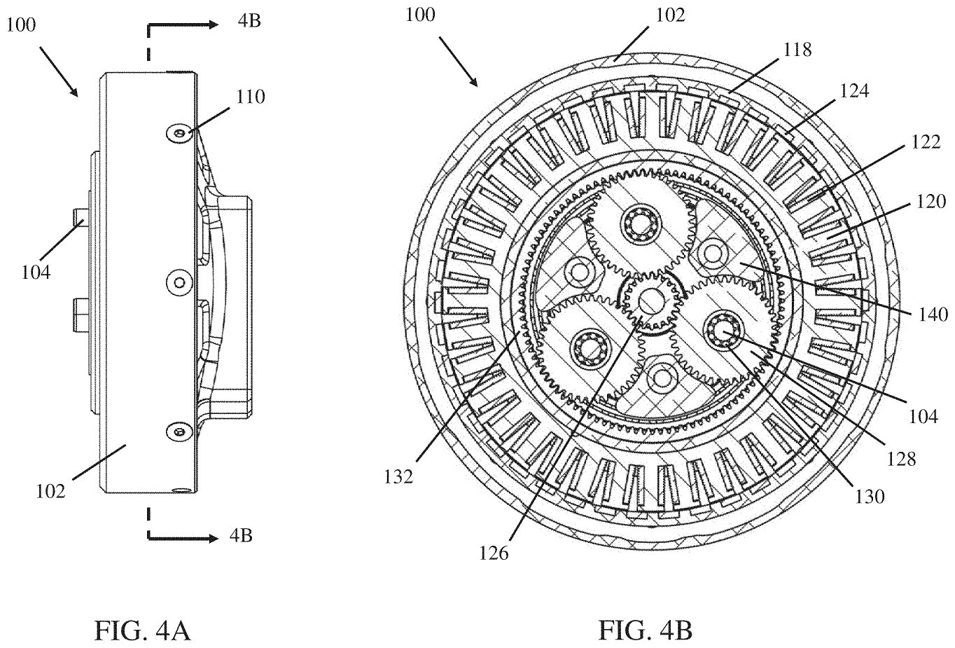

FIGS. 4A and 4B depict a back view and corresponding cross sectional view of one embodiment of an actuator 100. As above, a housing may include a first housing portion 102 coupled to a second housing portion by one or more fasteners 110. Additionally, the figures illustrate the location and arrangement of the one or more poles 122 of a stator 120 disposed circumferentially around a perimeter of the stator. Again when the one or more poles are supplied with an electrical current, they produce a magnetic field that exerts a force on one or more magnets 124 disposed circumferentially around a rotor 118, causing the rotor to rotate about its longitudinal axis relative to the stator. Again, the rotor may be operatively coupled to a sun gear 126, so that the sun gear rotates as the rotor rotates. This may in turn rotate the associated one or more planet gears 128, planet carrier 140, and one or more output studs 104 as described above. Thus, in some embodiments, supplying an electrical current to the stator may cause the output studs, or other appropriate output of an actuator, to rotate.

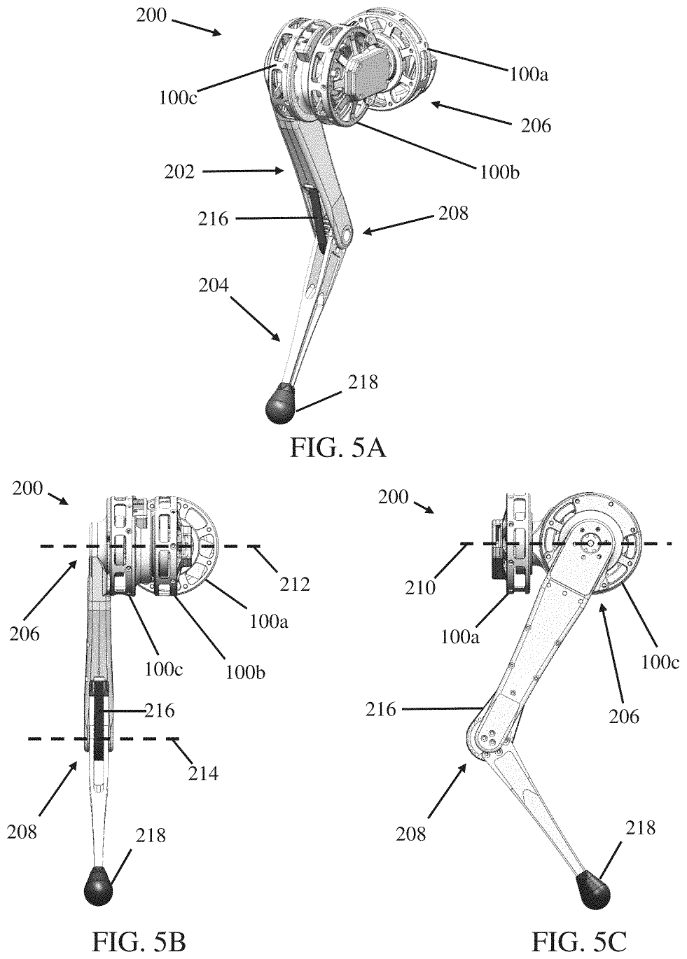

FIGS. 5A-5C illustrate various views of one embodiment of a robotic limb 200. In the depicted embodiment, the robotic limb comprises a first robotic limb segment 202 and a second robotic limb segment 204. The limb segments may correspond to rods, shafts, tubes, plates, and/or any other appropriate structure capable of transmitting and supporting a force and/or torque applied to the limb segment by an associated actuator and/or a supporting surface located adjacent to a portion of the robotic limb. In either case, the robotic limb may also include a first joint 206 operatively coupled to a proximal portion of the first robotic limb segment and a second joint 208 operatively coupled to a distal portion of the first robotic limb segment and a proximal portion of the second robotic limb segment. A first actuator 100a is configured to rotate the first joint about a first axis 210. A second actuator 100b is also configured to rotate the first joint about a second axis 212. As depicted in the figure, the first and second actuators may be connected to each other in series such that an output of the first actuator may be connected to a portion of a housing of the second actuator. Accordingly, an output from the first actuator may rotate both the second actuator and the first limb segment about the first axis and an output from the second actuator may rotate the first limb segment about the second axis. In some embodiments, the robotic limb may also include a third actuator 100c configured to rotate the second joint about a third axis 214. Depending on the particular embodiment, the third actuator 100c may be operatively coupled to the second joint 208 through a connection such as, for example, a belt or chain drive 216. However, it should be understood that any other appropriate connection, such as a chain drive, may be used, and the disclosure is not limited in this fashion. Additionally, the first, second, and third actuators may be coupled to one another in series as well.

In the above embodiment of a robotic limb, in some embodiments, at least one, and in some instances all, of the first actuator, the second actuator, and the third actuator may be a compact actuator as described herein. Further, although FIGS. 5A-5C generally depict the first actuator 100a, the second actuator 100b, and the third actuator 100c as being connected serially to one another and disposed at the first joint 206, it should be understood that any appropriate arrangement of the actuators in any appropriate joint may also be used.

Depending on the particular application, the above noted robotic limb 200 may also include a passive and/or actively actuated foot 218 disposed at a distal portion of the second robotic limb segment 204. As discussed above, in some embodiments, the foot may be included to introduce compliance into the robotic limb 200 as part of an effort to mitigate impacts applied to the robotic limb. However, it should be understood that other ways of designing the robotic limb for mitigating the effects of impact on the robotic limb may also be implemented as the disclosure is not limited in this fashion.

### Example: Actuator Build

An actuator was designed and built to simultaneously deliver high torque density, torque control bandwidth, and tolerance to external impacts. It used motors originally designed for remote control drones and airplanes, which are manufactured in huge quantities, at very low cost. These motors were tightly integrated with a 6:1 single-stage planetary gear reduction, a motor controller with built-in position sensor and joint-level control capabilities, a mechanical interface which can handle substantial moment loads for directly attaching limbs to the actuators, and a daisy-chainable power and communication system to simplify wiring using a system similar to that described above relative to the figures.

The electric motor used was nearly identical to the T-Motor U8, but made by a different manufacturer and available at significantly lower cost. This particular motor was chosen for its large airgap radius of 40.5 mm, a stack length of 8.2 mm, and a large number of pole-pairs, which give it particularly high torque density for an off-the-shelf motor.

To minimize the axial length of the actuator, the planetary gear system was placed inside the central bore that passed through the stator. The hardened pins which support the planet bearings extended through the output of the actuator, and served as locating and torque transmission features for the output. The transmission uses all stock gears, and as a result has roughly 0.3 degrees of backlash at the output.

A custom motor controller with integrated magnetic encoder IC was located behind the rotor in a controller housing integrated with the overall actuator housing as described above. The motor controller was designed for 24V nominal operation (although all components were rated for at least 40V), 30 A continuous current, and 40 A peak current. The controller was also constructed to handle field oriented control of motor currents at a loop rate of 40 kHz and closed-loop bandwidth of up to 4.5 kHz, as well as position and velocity control if desired. The controller received torque, position, velocity, and gain commands, and returned position, velocity, and estimated torque over a Controller Area Network (CAN) bus at a rate of up to:

$$\frac{4 kHz}{\# of actuators}$$

The actuator specifications of the as built actuators are summarized in Table I.

TABLE I
Actuator Specifications

| Mass | 440 | g |
|---|---|---|
| Dimensions | 96 mm O.D.; 40 mm axial length | |
| Maximum Torque | 17 | Nm |
| Continuous Torque | 6.9 | Nm |
| Maximum Output Speed | 40 rad/s @ 24 volts | |
| Maximum Output Power | +250/−680 | watts |
| Current Control Bandwidth | 4.5 kHz @ 4.5 Nm; 1.5 kHz @ 17 Nm | |
| Output Inertia | 0.0023 | kg m² |

The efficiency of the planetary gearbox was measured with a torque sensor on the output of the actuator. Gear and bearing friction was observed to be dependent on torque and rotation direction, with negligible speed dependence within the operating range of the actuator. The gear and bearing friction was well modeled by the following expression:

[symbol]

_{friction}=−0.09 sgn(ω)−0.04· [symbol] ₘₒₜₒᵣ sgn(ω)

where ω is the angular velocity of the output, τₘₒₜₒᵣ is equal to τᵣₒₜₒᵣ multiplied by the gear ratio, and the output torque τₒᵤₜₚᵤₜ is equal to the sum of τₘₒₜₒᵣ and τ_{friction}. This corresponded to a transmission efficiency of greater than 90% at torques above L5 N m, and greater than 94% at 4.5 N in and above.

### Example: Incorporation Into a Robot

The disclosed actuators were incorporated into a lightweight low-cost quadruped robot. It used identical modular actuators on every degree of freedom. Using identical, self-contained actuators for the three degrees of freedom of each robotic limb simplified robot design, and allowed for easy repairs and modification of the robot. Due to the resulting size, performance, and robustness of the robot incorporating the disclosed actuators, the robot also enabled rapid experimentation in hardware of highly dynamic behaviors.

Similar to what is shown in FIGS. 5A-5C, the robot's four identical legs were designed to maximize the robotic limb's range of motion while minimizing limb mass and inertia. The actuators had sufficient internal bearings for the three degrees of freedom to be serially attached with no additional support structure, which might add weight and limit range of motion. The hip and knee motors were located coaxially at the hip, to minimize the moment of inertia. Torque transmitted to the knee joint through a Gates Poly Chain belt transmission provided an additional 1.55:1 gear-up. The belt allowed +/−155 degrees range of motion from fully extended, so the robot was able to operate in both knee-forward and knee-backward configurations. The belt transmission did reduce torque control bandwidth at the knee by introducing a 30 Hz belt-actuator resonance. Though, the belt compliance was not observed to affect locomotion performance, the belt width may be easily increased to improve stiffness, at little weight or size penalty to the robot to change these performance characteristics of the robotic limb.

During operation of the robotic limb, the abduction adduction (ab/ad) joint was able to rotate +/−120 degrees, the hip joint was able to rotate +/−270 degrees (limited by wire length), and the knee joint was able to rotate +/−155 degrees. This range of motion allowed the robot to operate identically forwards, backwards, or upside-down, roll its body by 90 degrees to fit through narrow gaps, and climb obstacles much taller than its leg length.

In a full-collapsed configuration, near worst-case for vertical force production, each leg was observed to be capable of producing 150 N (1.7 bodyweights) peak and over 60 N (0.7 bodyweights) continuous vertical force. This indicates the robot shouldhave an additional payload capability of around its own bodyweight.

In addition to improving proprioceptive force control, the low limb inertia and low reflected actuator inertia of the above described robotic limbs made the robot capable of extremely fast leg-swings. For instance, the legs had an angular acceleration capability of 1700 rad s⁻² at the hip and ab/ad joints, and 5000 rad s⁻² at the knee joint. This corresponded to a linear acceleration of 875 m s⁻², or 89 G's, at the foot using only the knee motor. The body of the robot was a lightweight sheet aluminum monocoque which housed the battery, logic power supply, VN-100 IMU, wireless receiver and control computer.

To demonstrate the dynamic capabilities of the robot, and the utility of having a small, robust platform on which to experiment, offline nonlinear optimization was used to generate a back flipping trajectory, which was successfully executed on the robot. It is believed that this is the first example of a 360 degree flip on a quadruped robot.

As described above, a robot was designed and actuated using 12 identical low-cost, modular actuators, which were designed based on the actuation paradigm of using a high torque density electric motor coupled to a low-ratio transmission to achieve high torque density, backdrivablility, and high bandwidth force control through proprioception.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. An actuator comprising:
a stator;
a rotor that is rotatable relative to the stator, and wherein the rotor is coaxial with the stator; and
one or more gears disposed at least partially within a central bore passing axially through the stator and/or the rotor, wherein the one or more gears are operatively coupled to the rotor.

2. The actuator of claim 1, further comprising an output of the actuator operatively coupled to the one or more gears.

3. The actuator of claim 1, wherein at least one of the one or more gears are disposed within both the stator and the rotor.

4. The actuator of claim 1, wherein the rotor and stator at least partially overlap.

5. The actuator of claim 4, wherein the majority of the rotor and the stator overlap.

6. The actuator of claim 1, wherein the stator is disposed at least partially within the rotor.

7. The actuator of claim 1, wherein the rotor is disposed at least partially within the stator.

8. The actuator of claim 1, wherein the one or more gears comprise one or more selected from the group of a planetary gear system, a harmonic drive system, a spur gear system, and a cycloidal gear system.

9. The actuator of claim 1, wherein a gear ratio of the one or more gears is between or equal to 6:1 and 10:1.

10. The actuator of claim 1, wherein the actuator is backdrivable.

11. A method of operating an actuator, the method comprising:
driving one or more gears with a rotor of the actuator, wherein the one or more gears are at least partially disposed within a central bore passing axially through the rotor and/or a stator of the actuator.

12. The method of claim 11, further comprising rotating an output of the actuator with the one or more gears.

13. The method of claim 11, wherein g the one or more gears are disposed at least partially within both the stator and the rotor.

14. The method of claim 11, wherein the rotor and the stator at least partially overlap.

15. The method of claim 14, wherein a majority of the rotor and the stator overlap.

16. The method of claim 11, wherein the statoris at least partially disposed within the rotor.

17. The method of claim 11, wherein the rotor is at least partially disposed within the stator.

18. A robotic limb, the robotic limb comprising:
a first robotic limb segment;
a second robotic limb segment;
a first joint operatively coupled to a proximal portion of the first robotic limb segment;
a second joint operatively coupled to a distal portion of the first robotic limb segment and a proximal portion of the second robotic limb segment;
a first actuator configured to rotate the first joint about a first axis;
a second actuator operatively coupled to the first actuator and configured to rotate the first joint about a second axis; and
a third actuator configured to rotate the second joint about a third axis, wherein one or more selected from the group of the first actuator, the second actuator, and the third actuator are a compact actuator comprising:
a stator;
a rotor that is rotatable relative to the stator, and wherein the rotor is coaxial with the stator; and
one or more gears disposed at least partially within a central bore passing axially through the stator and/or the rotor, wherein the one or more gears are operatively coupled to the rotor.

19. The robotic limb of claim 18, wherein the second joint is operatively coupled to the third actuator through one or more selected from the group of a belt drive and a chain drive.

20. The robotic limb of claim 18, wherein each of the first, second, and third actuators are compact actuators.
